(19) United States
(12) Patent Application Publication
(10) Pub. No.: US 2004/0248530 A1
(43) Pub. Date: Dec. 9, 2004

(54) Analog front end multiplexer for CMTS receiver

(76) Inventors: Selim Shlomo Rakib, Cupertino, CA (US); Yehuda Azenkot, Cupertino, CA (US)

Correspondence Address: RONALD CRAIG FISH, A LAW CORPORATION, PO BOX 820, LOS GATOS, CA, 95032, US

(21) Appl. No.: 10/191,164

(22) Filed: Jul. 8, 2002

(51) Int. Cl. H04L 5/16

(52) U.S. Cl. 455/127.4; 375/222; 375/242

(57) ABSTRACT

An analog multiplexer front end circuit for a Cable Modem Termination System receiver to utilize one or a handful of CMTS receiver chips to receive and recover data from a larger number of input cables coupled to the analog multiplexer. A control circuit for the multiplexer uses MAP data and upstream mini-slot counts for each of the input cables to determine when a burst is about to arrive on an cable. In some embodiments, there is only one RF channel circuit coupled to the output of the multiplexer, so the multiplexer is controlled to couple the input cable upon which the burst is expected to the single RF channel. In other embodiments, there are multiple RF channels so the multiplexer is controlled to connect each input cable on which a burst is expected to an available W channel. In some embodiments, the sample data generated by each RF channel is buffered and an arbiter picks one burst at a time for application to the input of a CMTS receiver. In other embodiments, no buffers or arbiter are used, and each RF channel has its own dedicated CMTS receiver.

### FIELD OF USE AND BACKGROUND OF THE INVENTION

The invention finds utility in the field of Cable Modem Termination Systems (hereafter CMTS).

In the early stages of broadband cable modem deployment, frequently individual neighborhoods served by a cabl systeme do not have a full complement of customers.

Today, CMTS receivers are available that have the capability to handle a constant stream of bursts at 5.12 megasymbols per second. Such CMTS receivers are available from the assignee of the invention. If such a receiver is dedicated to serving one cable system coupled to the homes in one neighborhood, it will be underutilized during the initial stages of deployment because not enough bursts are being transmitted upstream from the served neighborhood to keep the CMTS receiver busy full time. This problem would exist if a single CMTS receiver is dedicated to each cable in a CMTS which is coupled to multiple cable systems.

The solution to this problem which has been attempted in the prior art is to concentrate all the bursts from all the cable systems serving multiple different neighborhoods together on one cable. This creates an even bigger noise problem than the cable upstream of a single cable system already has because all the noise from all the cables is concentrated into one cable that is coupled to the CMTS receiver. This therefore is an unsatisfactory solution since noise in the upstream is already a well recognized problem even in a single cable system. To multiply this noise problem by aggregating bursts from multiple cable systems into one cable is untenable.

### SUMMARY OF THE INVENTION

The solution to underutilization of CMTS receiver throughput provided by the present invention is use a commercially available analog multiplexer chip as the front end of a CMTS receiver and control it properly so that bursts from the different cable systems to which the CMTS receiver is coupled are selected at the right time for application to the input of the CMTS receiver. There are several different species within this genus, each applicable to a different situation. One situation is where the Media Access Control (MAC) process or processes which control upstream channel allocation control this allocation so that the bursts allocated to the various cable upstreams do not overlap in time. In this embodiment, a single RF channel with no buffer is selectively coupled through the multiplexer to the input cable upon which the burst will be arriving. The RF channel mixes the burst down to baseband and samples it. The samples are input to a CMTS receiver which recovers the payload data.

The RF channel can receive control information defining the center frequency of each logical channel so selected from the Media Access Control process or from the control circuit that controls the multiplexer.

In another situation, the MAC process allocates upstream bandwidth without restriction such that logical channels on various input cables can overlap in time or logical channels on the same cable can overlap in time so long as they do not overlap in bandwidth.

There can also be multimode channels on the same cable where multiple logical channels transmitted during different time intervals on the same carrier signal or at least on carrier signals with overlapping bandwidth and different center frequencies. In this situation, an embodiment is used with an analog multiplexer having multiple inputs each of which can be coupled to any one of a plurality of output radio frequency (RF) channels, each RF channel being bufferless and having an output which feeds the input of a dedicated CMTS receiver. The number of CMTS receivers is fewer than the number of input cables.

Another embodiment for this situation having overlap in time or bandwidth but not both is an embodiment which uses multiple RF channels each with a buffer. A single CMTS receiver or multiple CMTS receivers is/are shared and an arbiter selects burst data from the buffers according to any arbitration scheme and feeds the selected burst data into the input of the CMTS receiver(s) for recovery of the payload data. Each burst is processed in turn in this manner even though there may have been overlap in time between the bursts on the input cables.

### BRIEF DESCRIPTION OF THE DRAWINGS

FIG. 1 is a block diagram of a buffered embodiment of the invention with a shared single CMTS receiver and the components of the invention being restricted to those circuits within the shaded boxes in dashed lines.

FIG. 2 is a block diagram of the analog multiplexer 10 in FIG. 1.

FIG. 3 is a block diagram of one embodiment of a control circuit for the analog multiplexer.

FIG. 4 is a block diagram of another embodiment of a control circuit for the analog multiplexer.

FIG. 5 is a block diagram of an embodiment of an analog multiplexer based front end with multiple bufferless RF channel circuits and either a single CMTS receiver which can process multiple bursts simultaneously or multiple CMTS receivers, each dedicated to processing the output from one RF channel circuit.

FIG. 6 is a block diagram of a bufferless embodiment of an analog multiplexer front end with a single RF channel circuit and a single CMTS receiver.

### DETAILED DESCRIPTION OF THE PREFERRED AND ALTERNATIVE EMBODIMENTS

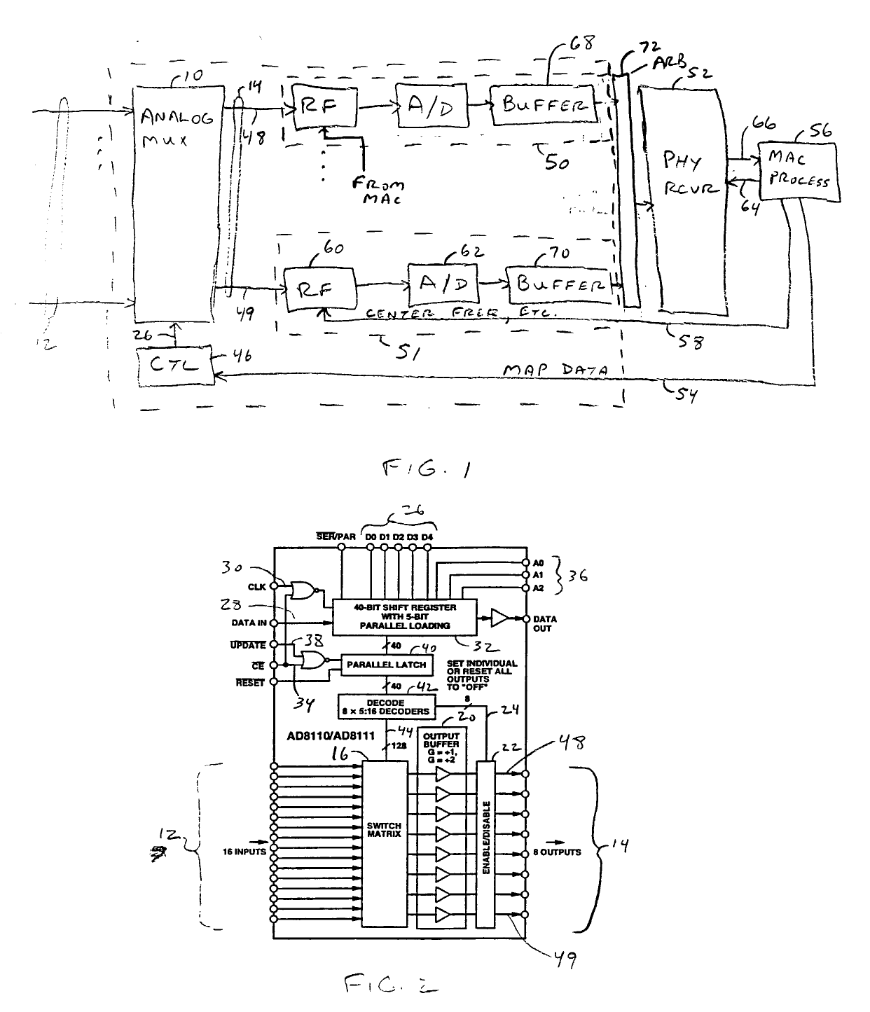

Referring to FIG. 1 there is shown a block diagram of a buffered embodiment of the invention with a shared single CMTS receiver. A single analog multiplexer 10 has multiple inputs 12 which are coupled to a plurality of separate cable systems, with the individual cable systems numbered from 1 to N where N=16 in this embodiment. The multiplexer 10 is a commercially available integrated circuit from Analog devices. Either model AD8110 or AD8111 will work. A block diagram of the multiplexer 10 is shown in FIG. 2 which is jointly referred to. The multiplexer 10 has a plurality of outputs shown at 14, which are fewer than the number of inputs, where 8 outputs are used in the preferred embodiment. Any one of the outputs can be coupled through the switch matrix 16 in FIG. 2 to any one of the analog signal inputs shown at 18. Any of the plurality of outputs shown at 14 can be coupled to any one input or any combination of more than one input. In the preferred embodiment, there are eight outputs and sixteen inputs. Each output is buffered by a buffer amplifier in buffer array 20, and each output can be enabled or disabled by control data on bus 24.

Control of the switch matrix 16 is accomplished by input of control words either in parallel format on bus 26 or in serial format on input line 28. A serial data clock is supplied on line 30. A 40-bit shift register 32 with 5-bit parallel loading via bus 26 or serial loading via line 28 stores the control word initially. Each 5-bit control word portion is steered to the correct portion of the shift register by a three bit address supplied on bus 36. A chip enable signal on line 34 enables the multiplexer to receive control data on a system bus (not shown) either in serial or parallel format. An update signal input 38 receives a signal which controls latching of the 40-bit stored control word into a parallel latch 40. A decoder 42 decodes the control word in latch 40 and generates the appropriate control signals on bus 44 to control the switch matrix 16 and the enable and disable circuits 22.

Returning to the consideration of FIG. 1, the multiplexer 10 is controlled by control circuitry 46 to select the appropriate input cable(s) from the group of N input cables for coupling to the appropriate output(s) 14 at the appropriate time. This is done using MAP data received on data path 54 from a Media Access Control (MAC) process 56 and upstream mini-slot counts for each input cable kept either by one or more mini-slot counters in the control circuit 46 or by one or more mini-slot counters in the MAC process with the current mini-slot count for each input cable transferred to the control circuitry via data path 54.

Each of the outputs 14 is coupled to any known RF channel circuitry suitable for cable modem usage. Further, any known PHY layer CMTS receiver 52 can be shared by all the outputs and RF channels. In the embodiment of FIG. 1, output channel 1 at 48 is coupled to RF channel 50 and the output of the RF channel is coupled to a shared PHY layer CMTS receiver 52. Likewise, output 49 is coupled to RF channel 51.

The function of each RF channel is to mix down to baseband the selected RF logical channel on the input cable to which the output coupled to the RF channel is connected. The RF channel also filters out noise in some embodiments, and, in all embodiments, each RF channel digitizes the selected logical channel it is processing and buffers the burst data. Suitable RF channel circuitry for channel 50 and PHY receiver circuitry for receiver 52 is disclosed in U.S. patent application Ser. No. 09/792,815, filed Feb. 23, 2001, and in a U.S. patent application entitled MULTICHANNEL, MULTIMODEDOCSIS HEADEND RECEIVER, filed Jun. 13, 2002, serial number unknown, both of which are owned by the assignee of the present invention, and both of which are hereby incorporated by reference. However, any other RF channel circuitry that can mix the selected channel down to baseband and filter out unwanted analog signals or data either before or after sampling by the analog to digital converter 62 will suffice to practice the invention.

In the buffered class of embodiments represented by FIG. 1, multiple bursts can be simultaneously processed in parallel in the RF channels such as RF channels 50 and 51, but the shared receiver 52 can only process one burst at a time in some embodiments or a couple of bursts at a time in other embodiments such as where the CMTS receiver has multiple pipeline stages each of which can process a burst while other stages are processing other bursts or where the CMTS receiver has a plurality of parallel circuit paths. Any CMTS receiver circuitry can be used as receiver 52. However, pipelined CMTS receivers are commercially available from Terayon Communications Systems, Inc. of Santa Clara, Calif. which have several pipeline sections and which are disclosed in the patent applications incorporated by reference herein. Each of these pipeline sections can be processing one burst while the other pipeline sections are processing other bursts. The RF channels buffer the sample data of the bursts they process in front end buffers such as 68 and 70 until an arbiter 72 supplies the selected burst data to the shared receiver 52. In species where the CMTS receiver 52 can only process one burst at a time, the arbiter 72 only supplies one burst at a time from the buffers using any suitable arbitration scheme such as bursts in buffers closest to overflow or highest service priority first or first-come-first served, or bursts encoding data from services that do not tolerate interruptions such as streaming video or audio first. In embodiments where the CMTS receiver can process more than one burst at a time such as pipelined receivers, the arbiter fills the first pipeline state of the receiver first and waits for that burst to be processed and move to the second pipeline stage, and then fills the first pipeline stage with data from another burst.

The function of the shared receiver 52 is to recover the data of each burst and to make measurements such as timing offsets necessary to communicate to the cable modems which transmitted the burst information they need to achieve upstream mini-slot boundary alignment. The receiver receives burst parameter data for each burst that defines how the receiver is to process the burst from the MAC process 56 via data path 64. Recovered payload data and measurements are supplied to the MAC process via data path 66.

Each logical channel can have various center frequencies and bandwidth in the upstream frequency range of the cable and each logical channel is transmitted during specific upstream mini-slots in Data Over Cable System (DOCSIS) compliant systems. The center frequency, bandwidth (symbol rate), modulation type, and assigned mini-slots (as well as other parameters) for each burst on each cable are controlled by a Media Access Control (MAC) process executing on a computer in the CMTS. The MAC process receives upstream bandwidth requests, assigns bandwidth according to some allocation scheme, and sends downstream bandwidth award messages to the various cable modems (CM) that sent the bandwidth requests. Bandwidth awards are sent in MAP messages. The center frequency and bandwidth of each burst to be processed by an RF channel along with other parameters such as modulation type are supplied to the RF channel from the MAC process via data paths such as path 58 for RF channel 51.

In the buffered embodiment of FIG. 1, the MAC process 56 (which is not part of the invention) controls the upstream bandwidth assignments so that there can be overlap in time between bursts to be received on different cables regardless of which cable the burst is to be transmitted upon. This why the buffers are needed. The function of the control circuit 46 is to: 1) receive MAP data from the MAC process via data path 54; 2) use one or more local upstream mini-slot counters either synchronized to the MAC upstream mini-slot counters or receive current upstream mini-slot counts from the MAC for each input cable via data path 54 so as to keep track of each cable's mini-slot number; 3) use the MAP data and the mini-slot counts for each cable to determine when to expect bursts; and 4) issue the appropriate control word on bus 26 to control the multiplexer 10 to select the input cable on which a burst is to be received and connect that input cable to an available one of the RF channels. Each RF channel then receives the appropriate control data from the MAC process 56 via a data path such as data path 58 to mix the selected logical channel down to baseband, filter it (in some embodiments), and digitize the channel and buffer the samples. Each RF channel has RF circuitry 60 and analog-to-digital conversion circuitry 62 as well as a buffer 70. Each input cable can have its own mini-slot count synchronized to a mini-slot counter in the MAC process dedicated to that cable. However, all the cables can also use a unified mini-slot count. The control circuit 46 keeps track of the mini-slot count on each cable regardless of where the mini-slot counters are and whether each cable has its own mini-slot count. The control circuit 46, in the preferred embodiment, keeps the MAP data for each input cable in a table and utilizes comparison circuitry to compare the current mini-slot count for each input cable to the MAP data to determine when a burst will arrive on each input cable. This comparison circuitry can be hardwired comparators or a programmed microprocessor. When a burst is about to arrive, an appropriate control word is generated on bus 26 (which can be in either serial or parallel format) which controls multiplexer 10 to connect the appropriate input cable to an RF channel circuit which is available. The control word generation can be by a decoder or a programmed microprocessor. The control circuit includes circuitry to keep track of which RF channel has been assigned to each burst and when that channel will be available based upon the duration of the burst as determined from the MAP data for the appropriate input cable. In this way, the control circuitry knows which RF channels are busy, and which are available for purposes of determining which radio frequency output 14 to couple to the radio frequency input 12 upon which the expected burst will be arriving.

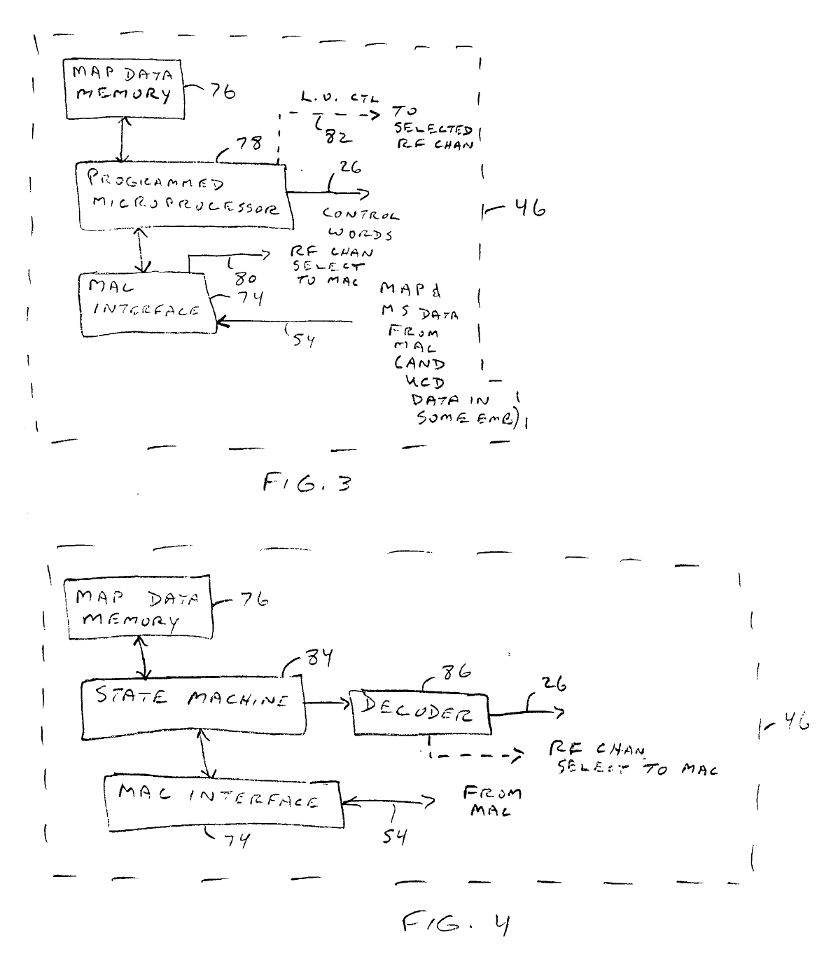

FIG. 3 is a block diagram of one embodiment for control circuit 46. In this embodiment, the upstream mini-slot count and the MAP data for each input cable is received via the MAC interface 74 and data path 54. The MAC interface has a structure which depends upon the nature of the data path 54. Data can be transferred by a parallel or serial format bus, a wireless or wired LAN or WAN link, by shared memory or any other interprocess transfer mechanism. The MAP data is stored in a memory 76 by microprocessor 78. Preferably, each input cable has a dedicated block of addresses in memory 76 in which the MAP data is stored. The current mini-slot count for each cable may also be stored in memory 76 or in on-board memory or registers in microprocessor 78. The microprocessor 78 is programmed to constantly compare the current mini-slot count for each input cable to the MAP data indicating when the next burst will be arriving for that input cable, and when the mini-slot count approaches the mini-slot number of the next expected burst, for generating an appropriate control word and control signals on bus 26 to control the analog multiplexer to connect the appropriate input cable to the appropriate output. The appropriate output is determined from an RF channel availability table the microprocessor 78 maintains indicating which RF channel has been assigned to each burst and how many mini-slots each said burst is scheduled to last from the MAP data for the burst. Before generating the control word, the microprocessor consults this RF channel availability table to select an available RF channel. In some embodiments, after selecting an RF channel, this information is transmitted back to the MAC process 56 via the MAC interface and data path 80 which can be the same data path upon which the incoming MAP and mini-slot data is received. This allows the MAC process to know to which RF channel to send UCD data for the burst defining the logical channel's center frequency and any other burst parameters needed by the RF channel's circuitry such as sample rate.

In alternative embodiments, the MAC process sends the UCD data for each logical channel's burst to the microprocessor 78 via data path 78. The microprocessor 78 then generates the appropriate frequency control word to control the frequency generated by a local oscillator in the RF channel circuit selected to process a particular burst to mix the burst's radio frequency signal down to baseband. This embodiment is represented by dashed line 82 carrying a local oscillator frequency control signal to a local oscillator frequency control word input of a local oscillator (not shown) of the selected RF channel input.

In other alternative embodiments, all the functions of the MAC interface and/or microprocessor 78 can be implemented in a state machine, as represented by FIG. 4, or glue logic including comparators, address generators, decoders, UARTs or parallel bus interfaces or other equivalent circuitry depending upon the embodiment for the interface to the MAC and the RC channel's local oscillator circuitry, e.g., does the RC channel local oscillator require a digital frequency control word such as is required by a direct digital synthesizer or an analog frequency control signal such as where a phase lock loop is used.

In FIG. 4, all circuits having the same reference numbers as circuits in FIG. 3 perform the same function. The function of the microprocessor 78 is performed by state machine 84 and decoder 86. The state machine constantly checks MAP data against the current mini-slot counts for each cable, and when a burst is about to arrive, selects an available RF channel from a channel availability table it maintains. Then a control word is generated on bus 26 by a decoder 86 from output signals from the state machine. Data about which RF channel has been selected is supplied to the MAC process 56 by the state machine via the MAC interface 74 or directly from the decoder 86.

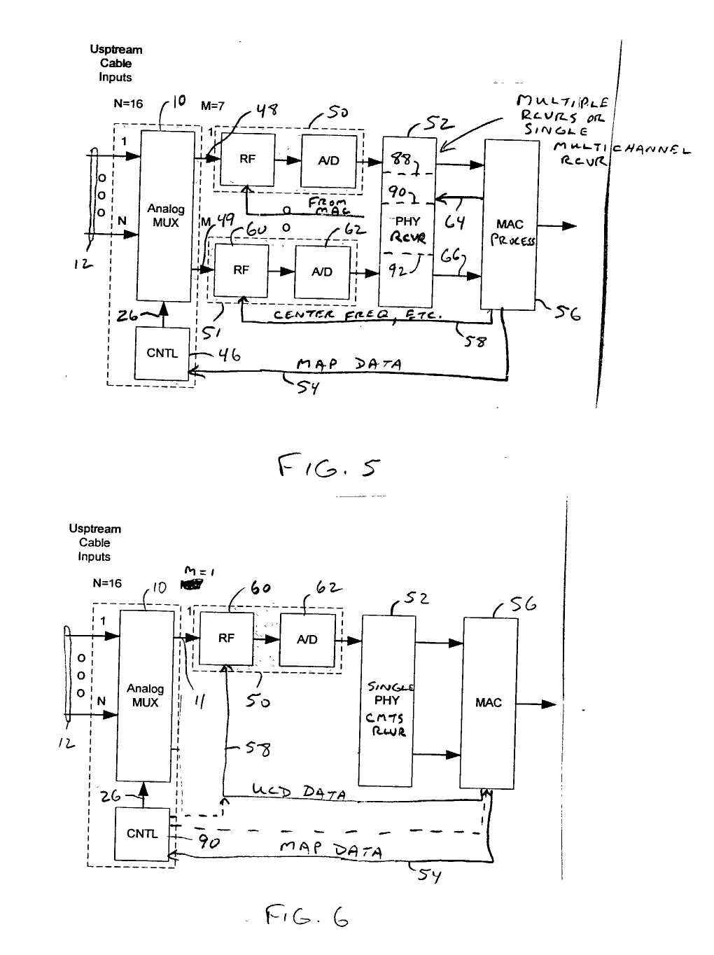

Referring to FIG. 5, there is shown a block diagram of a bufferless analog multiplexer front end where the CMTS receiver 52 is capable of parallel processing of multiple bursts simultaneously. All circuits having the same reference numbers as circuits in FIG. 1 have the same structure and function in the combination and have the same alternative embodiments. The analog multiplexer 10 receives control data on bus 26 from control circuit 46 which control which one or more of the plurality of outputs exemplified by 48 and 49 are connected to which one or more of the inputs 12. Each output is coupled to an RF channel circuit, each of which is comprised of and RF circuit 60 and an analog-to-digital sampler 62. The RF circuit 60 mixes the selected logical channel down to baseband and, in some embodiments, filters out unwanted signals. The A/D sampler preferably does wide band sampling. Each RF channel circuit receives control data which defines the center frequency of the selected logical channel which is modulated with the data of the burst to be processed. This data controls the frequency of a local oscillator signal generated by a local oscillator (not shown) in the RF circuit 60 which feeds a mixer to mix the burst's RF signal down to baseband. This control data can be received from the MAC process 56 as symbolized by data paths 58 to RF channel 51 and a similar data path to RF channel 50, or, in alternative embodiments, it can be received from the control circuit 46.

The RF channel circuits exemplified at 50 and 51, each output their bursts sample data on separate outputs coupled to a CMTS receiver 52 capable of processing multiple bursts simultaneously such as in parallel processing paths which share some common circuitry that can be shared. In alternative embodiments, the CMTS receiver block 52 is actually a separate CMTS receiver for each RF channel circuit, as symbolized by dashed lines 88, 90 and 92.

The control circuit 46 either has its own upstream mini-slot counters for each input cable synchronized to corresponding upstream mini-slot counters in the MAC process 56. In an alternative embodiment, the control circuit can have one upstream mini-slot counter synchronized to a corresponding upstream counter in the MAC process 56 if all the input cables have their upstream mini-slot counters synchronized to the same upstream mini-slot counter in the CMTS MAC process 56. In other alternative embodiments, the control circuit 46 receives the upstream mini-slot count for all the input cables 12 from the MAC process via data path 54.

In this embodiment of FIG. 5, there can be overlap in time between bursts on different cables as well as overlap in time between bursts on the same cable which are on different logical channels whose bandwidths do not overlap. There can also be multiple bursts on the same logical channel during different time division multiplexed intervals. The control circuit receives MAP data on data path 54 from the MAC process which defines which bursts are arriving on which input cables during which mini-slots and how long each burst is. The control circuit stores this MAP data and compares the MAP data for each cable to that cable's upstream mini-slot count to determine when each burst is about to arrive so that appropriate control words can be generated on bus 26. The control circuit keeps track of which RF channel circuits are available, and selects one to process each burst and generates appropriate control data on bus 26 to connect the correct input cable to the input of the selected RF channel. In some embodiments, the control circuit informs the MAC process 56 of each assignment of an RF channel and the timing of same so that the MAC process can send the appropriate UCD message data to the RF channel circuit to control the generation of a local oscillator signal to mix the burst down to baseband. In other embodiments, the control circuit receives the MAP and UCD data and generates the control signals which control each RF channel circuit's local oscillator. In embodiments where unwanted RF signals are filtered out by the RF channel circuit (most embodiments), either the MAC process 56 or the control circuit 46 will also send the symbol rate to the RF channel that processes each burst so that it knows the bandwidth of the burst and can set its filter coefficients properly to maximize the eliminated unwanted RF signals outside the bandwidth of the burst being processed.

Referring to FIG. 6, there is shown a block diagram of an analog multiplexer front end for a CMTS receiver where only a single bufferless RF channel circuit is used. In the embodiment of FIG. 6, the analog multiplexer 10 has multiple input cables and a single output 11 which is coupled to the input of a single RF channel circuit 50. In the embodiment of FIG. 6, the MAC process is limited to assigning bandwidth such that there is no overlap in time between logical channels on the different input cables. The RF channel circuit includes at least an RF circuit 60 which mixes the selected burst down to baseband and an analog-to-digital converter 62 which samples the baseband signal. In alternative embodiments, the RF channel circuit also includes a tunable digital or analog filter to remove noise outside the bandwidth of the burst being received. The RF channel circuit has an input 58 at which control data is received either from the MAC process 56 or the control circuit 90. This control data defines the center frequency of the logical channel to be received so that a local oscillator in the RF channel circuit can generate the proper frequency to mix the selected burst down to baseband. The control data can also include the symbol rate of the selected burst to define its bandwidth. This symbol rate data is used in embodiments of the RF channel circuitry which includes filters to set the coefficients of a digital filter or otherwise control the rolloff frequency or passband frequency limits so that the RF signal of the logical channel carrying the selected burst gets through and most noise outside the bandwidth of that logical channel is filtered out.

The control circuit 90 is structured to receive MAP data on data path 54 and store it and to either count upstream mini-slots on each input cable synchronously with upstream mini-slot counters in the MAC process 56 for the corresponding input cable or to receive the current mini-slot count for each input cable from the MAC process via data path 54 and store that in memory or just use the current mini-slot count of each cable in an ongoing round robin process of comparing the MAP data for the next expected burst on each input cable to the current mini-slot count for that cable. Control circuit 90 is different than the control circuits of FIGS. 1 and 5 since there is only one RF channel circuit and the control circuit 90 does not have to keep data indicating which of a plurality of RF channel circuits is currently available. The hardware structure of the control circuit 90 can be the same as in FIGS. 3 and 4, but the program is modified to not maintain data regarding the availability of an RF channel before generating control data to control the switching of the multiplexer 10. The process carried out by the control circuit 90, once it determines that a burst is about to arrive on a particular input cable, is simply to generate control word data on bus 26 which causes the multiplexer 10 to connect that input cable to the RF channel circuitry in time to process the burst.

Although the invention has been disclosed in terms of the preferred and alternative embodiments disclosed herein, those skilled in the art will appreciate possible alternative embodiments and other modifications to the teachings disclosed herein which do not depart from the spirit and scope of the invention. All such alternative embodiments and other modifications are intended to be included within the scope of the claims appended hereto.

What is claimed is:

1. An apparatus comprising:
an analog multiplexer having a plurality of analog radio frequency inputs and a plurality of analog radio frequency outputs, and having a control input for receiving control signals;
a plurality of radio frequency channel circuits (hereafter RF channels), each having an input coupled to one of said radio frequency outputs of said analog multiplexer; and
control means coupled to supply said control signals to said analog multiplexer to control the timing and selection of coupling each of one or more selected radio frequency outputs to one or more selected radio frequency inputs through said analog multiplexer.

2. The apparatus of claim 1 wherein each radio frequency control channel comprises:
mixer circuitry to mix the frequency of a selected logical channel in the input signal received from said analog multiplexer down to an analog baseband signal;
analog-to-digital conversion circuitry to sample said analog baseband circuitry; and
a buffer to store sample data output by said analog-to-digital conversion circuitry.

3. The apparatus of claim 2 further comprising a filter to filter out at least some frequencies outside the bandwidth of said selected logical channel.

4. The apparatus of claim 1 wherein said control means comprises:
a memory;
an interface circuit for communicating with a media access control process;
a programmed microprocessor coupled to said memory and said interface circuit and having an output coupled to said control input of said analog multiplexer.

5. The apparatus of claim 4 wherein said microprocessor is programmed to:
receive MAP data and the current mini-slot count for each radio frequency input of said multiplexer from a Media Access Control process (hereafter MAC process) and store said MAP data and said current mini-slot count in said memory;
compare the current mini-slot count for each radio frequency input of said multiplexer to MAP data for said input to determine when to expect a burst on said input;
maintaining a list of available radio frequency channel signals using said MAP data and data regarding which assignments have been made to which RF channels to process bursts;
when a burst is to be received, selecting an available RF channel using said list of available radio frequency channels, and generating appropriate control signals to control said multiplexer to connect a radio frequency input on which said burst will arrive to said radio frequency output coupled to said available RF channel.

6. The apparatus of claim 5 wherein said microprocessor is programmed to send data regarding which RF channel has been assigned to process each burst to said MAC process.

7. The apparatus of claim 5 wherein each said RF channel circuit includes an input coupled to receive data from said MAC process which controls the frequency of a local oscillator signal which said RF channel circuit mixes with a radio frequency signal modulated with the data of a burst to be received to mix said burst's radio frequency signal down to baseband.

8. The apparatus of claim 5 wherein said microprocessor is programmed to generate an appropriate control signal for a local oscillator in said RF channel circuit assigned to process each burst and to transmit said control signal to said local oscillator to cause said local oscillator to generate a local oscillator signal having a frequency which when mixed with the frequency of the radio frequency signal modulated with said burst to be received causes said radio frequency signal modulated with said burst to be received to be mixed down to baseband.

9. The apparatus of claim 1 wherein said control means comprises:
a memory;
an interface circuit for communicating with a media access control process;
a state machine coupled to said memory and said interface circuit and coupled directly or indirectly through a decoder to said control input of said analog multiplexer.

10. The apparatus of claim 1 further comprising:
a buffer in each said RF channel circuit coupled to receive and store sample data output by an analog-to-digital conversion circuit in said RF channel circuit;
any arbiter coupled to said buffers and having an output, for selecting burst data stored in said buffers according to any arbitration scheme and presenting said burst data at said output;

11. The apparatus of claim 10 further comprising any Cable Modem Termination System receiver having a burst data input coupled to said output of said arbiter.

12. The apparatus of claim 1 further comprising a plurality of Cable Modem Termination Systems receivers, each being of any type and each having a burst data input coupled to an output of an RF channel.

13. An apparatus comprising:
an analog multiplexer having a plurality of analog radio frequency inputs and a plurality of analog radio frequency outputs, and having a control input for receiving control signals;
a plurality of radio frequency channel circuits (hereafter RF channels), each having an input coupled to one of said radio frequency outputs of said analog multiplexer and each comprising at least a mixer to mix a selected logical channel down to baseband and an analog-to-digital converter to sample the baseband signals and a buffer to store samples output by said analog-to-digital converter; and
control means coupled to supply said control signals to said analog multiplexer to control the timing and selection of coupling each of one or more selected radio frequency outputs to one or more selected radio frequency inputs through said analog multiplexer;
any arbiter structured and coupled to read data from each said buffer and output data for one burst at a time according to any arbitration scheme; and
any Cable Modem Termination System receiver coupled to receive the selected burst data from said arbiter.

14. An apparatus comprising:
an analog multiplexer having a plurality of analog radio frequency inputs and a plurality of analog radio frequency outputs, and having a control input for receiving control signals;
a plurality of radio frequency channel circuits (hereafter RF channels), each having an input coupled to one of said radio frequency outputs of said analog multiplexer and each comprising at least a mixer to mix a selected logical channel down to baseband and an analog-to-digital converter to sample the baseband signals; and
control means coupled to supply said control signals to said analog multiplexer to control the timing and selection of coupling each of one or more selected radio frequency outputs to one or more selected radio frequency inputs through said analog multiplexer;
a plurality of any type of Cable Modem Termination System receivers, each coupled to receive output data from an RF channel.

15. The apparatus of claim 14 wherein each RF channel circuit has an input to receive control data from a Media Access Control process which defines the center frequency of the logical channel upon which data of a burst to be processed by said RF channel circuit is modulated, and wherein said control circuit is structured to assign each burst to an available RF channel circuit and to maintain data regarding the availability of each RF channel circuit and to inform said Media Access Control process each time an assignment of an RF channel circuit is made.

16. The apparatus of claim 14 wherein each RF channel circuit includes a digital filter and has an input to receive control data from a Media Access Control process which defines the center frequency and symbol rate of the logical channel upon which data of a burst to be processed by said RF channel circuit is modulated, and wherein said control circuit is structured to assign each burst to an available RF channel circuit and to maintain data regarding the availability of each RF channel circuit and to inform said Media Access Control process each time an assignment of an RF channel circuit is made, and wherein said RF channel circuit is structured to use said control data defining the center frequency of said logical channel to control a local oscillator to generate a signal which when mixed with said logical channel signal mixes said logical channel down to baseband, and is further structured to use said control data defining said symbol rate to set filter coefficients for said digital filter which filters out at least some noise outside the bandwidth of said logical channel.

17. The apparatus of claim 14 wherein each RF channel circuit has an input to receive control data from said control circuit which defines the center frequency of the logical channel upon which data of a burst to be processed by said RF channel circuit is modulated.

18. The apparatus of claim 14 wherein each RF channel circuit has a digital filter and has an input to receive control data from said control circuit which defines the center frequency and symbol rate of the logical channel upon which data of a burst to be processed by said RF channel circuit is modulated, and wherein said RF channel circuit is structured to use said control data defining said center frequency to control the frequency of a local oscillator signal which is mixed with said logical channel signal to mix it down to baseband, and is further structured to use said control data defining said symbol rate to set coefficients of said digital filter to filter out at least some signals outside the bandwidth of said logical channel.

19. An apparatus comprising:
an analog multiplexer having a plurality of analog radio frequency inputs and a single analog radio frequency output, and having a control input for receiving control signals;
a single radio frequency channel circuit (hereafter RF channels), having an input coupled to one of said radio frequency output of said analog multiplexer, and comprising at least a mixer to mix a selected logical channel down to baseband and an analog-to-digital converter to sample the baseband signals; and
control means coupled to supply said control signals to said analog multiplexer to control the timing and selection of coupling said radio frequency output to a selected radio frequency input through said analog multiplexer to receive a burst modulated onto the radio frequency signals of a logical channel;
a Cable Modem Termination System receiver coupled to receive output data from said RF channel.

20. The apparatus of claim 19 wherein said RF channel includes a tunable filter to filter out most noise outside the passband of the selected logical channel.

21. The apparatus of claim 20 wherein said RF channel includes an input for receiving control data which defines the center frequency of the selected logical channel and which defines the symbol rate and bandwidth of said selected logical channel, and wherein said RF channel circuitry is structured to use said control data to define the frequency generated by a local oscillator to mix the selected logical channel down to baseband and to use said control data defining the bandwidth to tune said filter to filter out most of the noise outside the bandwith of said selected logical channel.

22. A process comprising:
receiving and storing MAP data for each of a plurality of input cables each cable carrying bursts of upstream data transmitted on RF signals of a logical channel during mini-slots assigned by a Media Access Control process, said MAP data defining the beginning and ending mini-slot of each burst on each cable;
determining the current upstream mini-slot count for each of said input cables;
comparing the current mini-slot count for each cable to the MAP data for said input cable, and generating switching control data to control switching of an analog multiplexer having a plurality of inputs coupled to said input cables to connect an input cable upon which a burst will be arriving to an available RF channel circuit for processing;
mixing the RF signals of the selected burst down to baseband and taking digital samples of the baseband signal.

23. A process comprising:
receiving and storing MAP data for each of a plurality of input cables each cable carrying bursts of upstream data transmitted on RF signals of a logical channel during mini-slots assigned by a Media Access Control process, said MAP data defining the beginning and ending mini-slot of each burst on each cable;
determining the current upstream mini-slot count for each of said input cables;
comparing the current mini-slot count for each cable to the MAP data for said input cable, and generating switching control data to control switching of an analog multiplexer having a plurality of inputs coupled to said input cables to connect an input cable upon which a burst will be arriving to an available RF channel circuit for processing after determining which of a plurality of RF channel circuits is available to process a burst;
in each RF channel circuit which has been assigned to process a burst, mixing the RF signals of the selected burst down to baseband and taking digital samples of the baseband signal;
in each RF channel circuit, storing said sample data in a buffer;
arbitrating between RF channels to read sample data out of the buffers of said RF channels on the basis of any arbitration scheme and providing the selected sample data at an output; and
receiving the selected sample data and recovering said burst data therefrom.

24. A process comprising:
receiving and storing MAP data for each of a plurality of input cables each cable carrying bursts of upstream data transmitted on RF signals of a logical channel during mini-slots assigned by a Media Access Control process, said MAP data defining the beginning and ending mini-slot of each burst on each cable;
determining the current upstream mini-slot count for each of said input cables;
comparing the current mini-slot count for each cable to the MAP data for said input cable, and generating switching control data to control switching of an analog multiplexer having a plurality of inputs coupled to said input cables to connect an input cable upon which a burst will be arriving to an available RF channel circuit for processing after determining which of a plurality of RF channel circuits is available to process a burst;
in each RF channel circuit which has been assigned to process a burst, mixing the RF signals of the selected burst down to baseband and taking digital samples of the baseband signal;
receiving the sample data from each RF channel in a Cable Modem Termination System receiver dedicated to said RF channel, and recovering said burst data therefrom.
